(19) United States
(12) Patent Application Publication
(10) Pub. No.: US 2024/0414080 A1
(43) Pub. Date: Dec. 12, 2024

(54) WIRELESS DATA TRANSMISSION SYSTEM AND WIRELESS DATA TRANSMISSION METHOD

(71) Applicant: PANASONIC HOLDINGS CORPORATION, Osaka (JP)

(72) Inventors: Kazuhiro EGUCHI, Fukuoka (JP); Yoshio KOYANAGI, Kanagawa (JP); Ryosuke HASABA, Kanagawa (JP); Hisao KOGA, Fukuoka (JP); Shuichiro YAMAGUCHI, Fukuoka (JP); Ryota YUKIZANE, Fukuoka (JP); Naohiro KAWABATA, Fukuoka (JP); Issei IKEZAKI, Fukuoka (JP)

(73) Assignee: PANASONIC HOLDINGS CORPORATION, Osaka (JP)

(21) Appl. No.: 18/695,589

(22) PCT Filed: Aug. 29, 2022
(86) PCT No.: PCT/JP2022/032469

§ 371 Date: Mar. 26, 2024

(30) Foreign Application Priority Data
Sep. 27, 2021 (JP) 2021-156850

(51) Int. Cl. H04L 45/16; H04B 13/02; H04L 45/02

(52) U.S. Cl. CPC H04L 45/16; H04B 13/02; H04L 45/02

(57) ABSTRACT

A wireless data transmission system includes N (N is an integer equal to or greater than 2) transmission coils each disposed under water such that an opening surface thereof faces vertically upward, and N communication devices each connected in a one-to-one correspondence to a connected transmission coil which is any one of the N transmission coils and each configured to perform data communication via the corresponding connected transmission coil. Each of the communication devices performs multi-hop transmission of data, which is acquired by a data acquiring device movable under the water, based on a topology generated in advance and indicating a connection mode between the N communication devices and magnetic field coupling occurring between the connected transmission coil and other connected transmission coils adjacent thereto.

### TECHNICAL FIELD

The present disclosure relates to a wireless data transmission system and a wireless data transmission method.

### BACKGROUND ART

Patent Literature 1 discloses a marine network system in which many buoys are arranged in the sea each including a float floating on a sea surface and a communication unit main body connected to the float and each suspended in the sea, and the many buoys perform communication with one another within a certain range. The communication unit main body performs submarine communication using laser light with a plurality of other communication unit main bodies that are present within a certain distance around the communication unit main body. At least one of the buoys functions as a base station relay buoy that communicates with a base station, the float of the base station relay buoy includes a communication cable for communicating with the communication unit main body connected to the float, and a wireless communication unit that communicates wirelessly with the base station.

Patent Literature 2 discloses an information communication system in which transmission data generated by a data management server is distributed, by ultrasonic waves, to an underwater sailing body, that conducts ocean research, via an artificial satellite and a first data transmission and reception terminal.

### CITATION LIST

### Patent Literature

Patent Literature 1: JP2017-184034A

Patent Literature 2: JP2015-56831A

### SUMMARY OF INVENTION

### Technical Problem

In recent years, when an underwater sailing body that performs exploration in ocean exploration or the like is put into the sea, data acquired by the underwater sailing body is transmitted to a surface vehicle or the like by wireless communication, thus improving the efficiency of data collection. In particular, in the ocean exploration using the underwater sailing body; it is desirable to perform data communication over a wider range because an exploration region often spreads over a wide area.

In the communication using laser light as disclosed in Patent Literature 1, although a communication speed is high, communication is difficult depending on an installation position or a state of the sea (for example, cloudy), or communication is difficult when a topography of the exploration region is highly undulated or curved, or communication over a long distance is difficult. Further, in the communication using ultrasonic waves as disclosed in Patent Literature 2, communication over a long distance is possible, but there is a problem in that a speed of the data transmission is slow. That is, in the above-described Patent Literatures 1 and 2, it is difficult to perform large-capacity data communication at a high speed and stably in a wide range such as the sea, and there is a room for improvement.

The present disclosure has been made in view of the above-described circumstances in the related art, and provides a wireless data transmission system and a wireless data transmission method in which large-capacity data communication is performed at a high speed and stably in a wide range such as the sea.

### Solution to Problem

The present disclosure provides a wireless data transmission system including N (N is an integer equal to or greater than 2) transmission coils each having an opening surface and each disposed under water such that the opening surface faces vertically upward: and N communication devices each connected in a one-to-one correspondence to a connected transmission coil which is any one of the N transmission coils and each configured to perform data communication via the corresponding connected transmission coil, in which each of the communication devices performs multi-hop transmission of data, that is acquired by a data acquiring device movable under the water, based on a topology generated in advance and indicating a connection mode between the N communication devices and magnetic field coupling occurring between the connected transmission coil and at least one of other connected transmission coils adjacent thereto.

Further, the present disclosure provides a wireless data transmission method including using N (N is an integer equal to or greater than 2) transmission coils each having an opening surface and each disposed under water such that the opening surface faces vertically upward, and N communication devices each connected in a one-to-one correspondence to a connected transmission coil which is any one of the N transmission coils and each configured to perform data communication via the corresponding connected transmission coil; and performing multi-hop transmission of data, that is acquired by a data acquiring device movable under the water, based on a topology generated in advance and indicating a connection mode between the N communication devices and magnetic field coupling occurring between the connected transmission coil and at least one of other connected transmission coils adjacent thereto.

### Advantageous Effects of Invention

According to the present disclosure, large-capacity data communication can be performed at a high speed and stably in a wide range such as the sea.

### BRIEF DESCRIPTION OF DRAWINGS

FIG. 1 is a diagram schematically showing an example of a usage environment in which a wireless data transmission system is installed.

FIG. 2 is a diagram schematically showing a system configuration example of the wireless data transmission system.

FIG. 3 is a diagram showing an example of magnetic field coupling between transmission coils arranged in a horizontal direction.

FIG. 4 is a block diagram showing a hardware configuration example of a PLC adapter.

FIG. 5 is a block diagram showing a functional configuration example of a CPU of the PLC adapter.

FIG. 6 is a sequence diagram showing a processing procedure example of authentication processing performed between an M-PLC and a t-PLC.

FIG. 7 is a diagram showing a first example of an arrangement of the PLC adapters and link costs between the PLC adapters.

FIG. 8 shows a first topology example.

FIG. 9 is a sequence diagram showing a processing procedure example of authentication processing performed between the various PLC adapters shown in FIG. 7.

FIG. 10 is a diagram showing a second example of the arrangement of the PLC adapters and the link costs between the PLC adapters.

FIG. 11 shows a second topology example.

FIG. 12 is a sequence diagram showing a processing procedure example of authentication processing performed between the various PLC adapters shown in FIG. 10.

### DESCRIPTION OF EMBODIMENTS

Hereinafter, embodiments specifically disclosing a wireless data transmission system and a wireless data transmission method according to the present disclosure will be described in detail with reference to the drawings as appropriate. However, unnecessarily detailed descriptions may be omitted. For example, the detailed description of well-known matters and the redundant description of substantially the same configuration may be omitted. This is to avoid unnecessary redundancy of the following description and to facilitate understanding of a person skilled in the art. The accompanying drawings and the following description are provided for those skilled in the art to fully understand the present disclosure and are not intended to limit the subject matters described in the claims.

### System Configuration

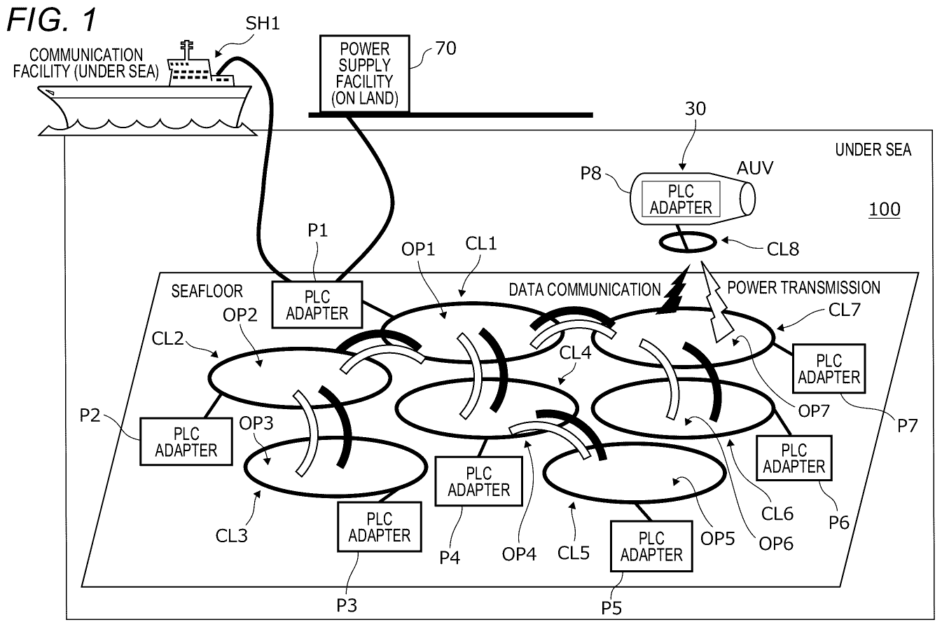

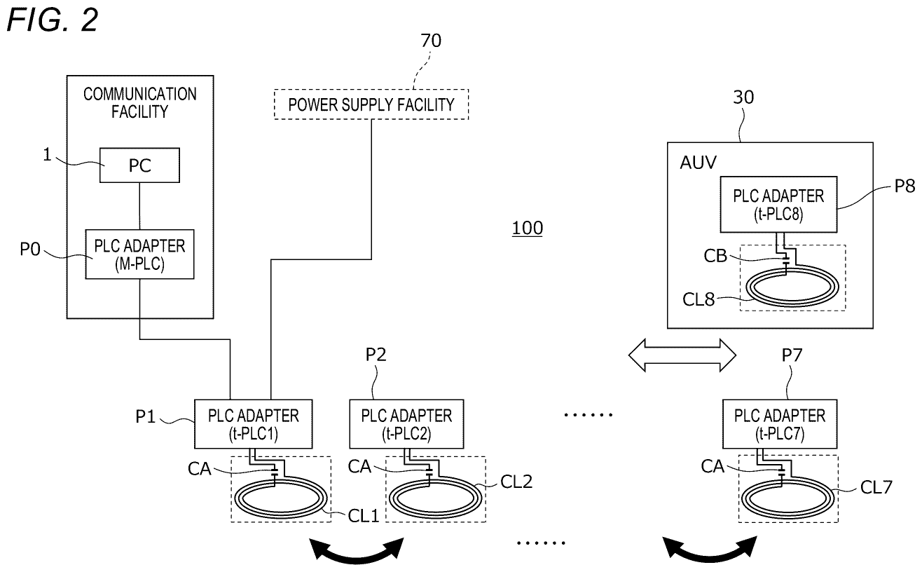

FIG. 1 is a diagram schematically showing an example of a usage environment in which a wireless data transmission system 100 is installed. FIG. 2 is a diagram schematically showing a system configuration example of the wireless data transmission system 100. As shown in FIG. 1, the wireless data transmission system 100 is disposed under the water (for example, under the sea). The wireless data transmission system 100 includes N (N: an integer equal to or greater than 2) transmission coils and N PLC adapters. The transmission coils include, for example, transmission coils CL1, CL2, CL3, CL4, CL5, CL6, and CL7. The PLC adapter is an example of a communication device, and the PLC adapters include, for example, PLC adapters P1, P2, P3, P4, P5, P6, and P7. In the example of FIG. 1, N=7, but N is not limited to 7 as long as N is 2 or more.

Each of the transmission coils CL1 to CL7 is formed in an annular shape, for example, is insulated by being covered with a resin cover, and performs not only power transmission but also data communication with another transmission coil that is magnetic field-coupled by a magnetic field coupling method (in other words, an electromagnetic induction method). Each of the transmission coils CL1 to CL7 is formed of, for example, a cab-tire cable, a helical coil, or a spiral coil. The helical coil is an annular coil wound in a helical shape along a transmission direction of electric power according to the magnetic field coupling method, not in the same plane. By adopting the helical coil, a wide space inside each of the wound transmission coils CL1 to CL7 can be secured. The spiral coil is an annular coil formed in a spiral shape in the same plane. By adopting the spiral coil, a thickness of each of the transmission coils CL1 to CL7 can be reduced. FIG. 1 illustrates an example of the spiral coil.

In addition, the transmission coils CL1, CL2, CL3, CL4, CL5, CL6, and CL7 respectively have opening surfaces OP1, OP2, OP3, OP4, OP5, OP6, and OP7, and are disposed in the sea (for example, on a seafloor) such that the opening surfaces face vertically upward. Here, the vertically upward direction indicates a direction toward a sea surface that exists on an upward side in a vertical direction, which is substantially perpendicular to a seafloor surface that can be considered to be substantially flat.

For example, the transmission coils CL1 to CL7 are disposed at equal intervals. A distance (in other words, an interval) between the adjacent transmission coils is, for example, 5 m. The interval is, for example, half of a diameter of the transmission coil. A transmission frequency is, for example, 40 kHz or lower in consideration of an amount of attenuation of a magnetic field strength under the water (for example, under the sea), and in particular is preferably lower than 10 KHz. In a case of power transmission performed at a transmission frequency of 10 KHz or higher, a predetermined simulation needs to be performed based on provisions of the Radio Law; and in a case of power transmission performed at a transmission frequency lower than 10 KHz, the operation can be omitted. As the transmission frequency decreases, a power transmission distance increases, the transmission coil increases in size, and the interval increases. The transmission frequency may be, for example, a frequency higher than 40 kHz when a data communication signal is superimposed.

The transmission frequency is determined based on coil characteristics such as inductance, a diameter, and the number of turns of the transmission coil. The diameter of the transmission coil is, for example, several meters to several tens of meters. As the thickness of the transmission coil increases (that is, as a wire diameter of the transmission coil increases), electric resistance in the transmission coil decreases, and power loss decreases. In addition, electric power transmitted via the transmission coil is, for example, 50 W or more, and may be in the order of kW.

As shown in FIG. 2, capacitors CA, CA, . . . , CA, CB are connected in series to the transmission coils CL1, CL2, . . . , CL7, CL8, respectively. A resonance circuit is formed by each of the transmission coil CL1 and the capacitor CA, the transmission coil CL2 and the capacitor CA, . . . , the transmission coil CL7 and the capacitor CA, and the transmission coil CL8 and the capacitor CB. Each of the transmission coils CL1 to CL7 transmits data or electric power received from the corresponding PCL adapter connected to the transmission coil itself (for example, the PLC adapter P1 corresponding to the transmission coil CL1) toward other transmission coils adjacent thereto.

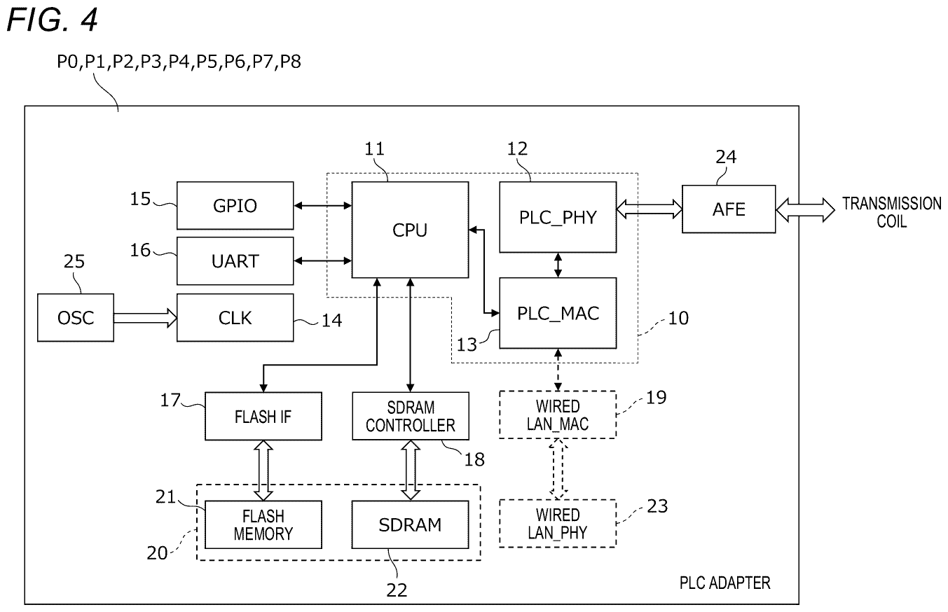

The PLC adapter P1 is disposed, for example, on the seafloor. The PLC adapter P1 is connected in a wired manner to allow communication with a communication facility (for example, the PLC adapter P0 shown in FIG. 2) provided in a ship SH1 anchored on the sea (an example of water), and is further connected to a power supply cable or the like to allow supply of electric power from a power supply facility 70 installed on land. The PLC adapter P1 is connected to the transmission coil CL1 (an example of a connected transmission coil) in a wired manner, and acquires, via the transmission coil CL1, data transmitted from another transmission coil (for example, various types of data acquired by an AUV 30 in ocean exploration or the like). The PLC adapter P1 performs data communication with the PLC adapter P0, and feeds electric power to another transmission coil while receiving and feeding electric power transmitted from the power supply facility 70. A detailed configuration example of the PLC adapter P1 will be described later with reference to FIG. 4.

Each of the PLC adapters P2, P3, P4, P5, P6, and P7 is disposed on the seafloor, for example, is connected to the corresponding one of the transmission coils CL2, CL3, CL4, CL5, CL6, and CL7 (an example of the connected transmission coil) in a wired manner, and acquires data that is transmitted from another transmission coil (for example, various types of data acquired by the AUV 30 in ocean exploration or the like), or receives and feeds electric power, that is transmitted from another transmission coil, via the corresponding one of the transmission coils CL2, CL3, CL4, CL5, CL6, and CL7. In addition, each of the PLC adapters P2, P3, P4, P5, P6, and P7 transmits data that is acquired from another transmission coil (for example, various types of data acquired by the AUV 30 in ocean exploration or the like) or feeds electric power that is acquired from another transmission coil to another transmission coil via the corresponding one of the transmission coils CL2, CL3, CL4, CL5, CL6, and CL7. A detailed configuration example of each of the PLC adapters P2 to P7 will be described later with reference to FIG. 4.

Further, the wireless data transmission system 100 may further include the autonomous underwater vehicle (AUV) 30 that is an underwater sailing body. The AUV 30 may be, for example, a remotely operated vehicle (ROV), an unmanned underwater vehicle (UUV), or an autonomous underwater vehicle (AUV). The AUV 30 may be equipped with a built-in battery (not shown).

The AUV 30 includes the transmission coil CL8 and the PLC adapter P8. The AUV 30 may include an acquisition mechanism (not shown) capable of acquiring various types of data (see the above) related to the ocean exploration, and transmits the data acquired by the acquisition mechanism to another transmission coil via the transmission coil CL8. The data includes, for example, data of an exploration result obtained by underwater exploration or water bottom exploration using the AUV 30. The AUV 30 is navigated under the water, and is capable of moving freely to a predetermined data acquisition point based on an instruction from the ship SH1 (specifically; PC1). The instruction from the ship SH1 may be transmitted by data communication via the transmission coils CL1 to CL8, or may be transmitted by another communication method.

The PLC adapter P8 is disposed in the AUV 30, is connected to the transmission coil CL8 in a wired manner, and acquires data that is transmitted from another transmission coil or receives and feeds electric power, that is transmitted from another transmission coil, via the transmission coil CL8. The PLC adapter P8 transmits the data (see the above) acquired from the AUV 30 to another transmission coil via the transmission coil CL8. A detailed configuration example of the PLC adapter P8 will be described later with reference to FIG. 4. A transmission source and a transmission destination of the data (see the above) of the transmission coil are defined by topology to be generated, and will be described in detail later.

A part of the ship SH1 on which the communication facility is disposed is present above a water surface (for example, a sea surface), that is, on the water, and another part of the ship SH1 is present below the water surface, that is, under the water (for example, under the sea). The ship SH1 is movable on the water (for example, on the sea), and can freely move to, for example, a water surface (for example, a sea surface) of a data acquisition place for the AUV 30.

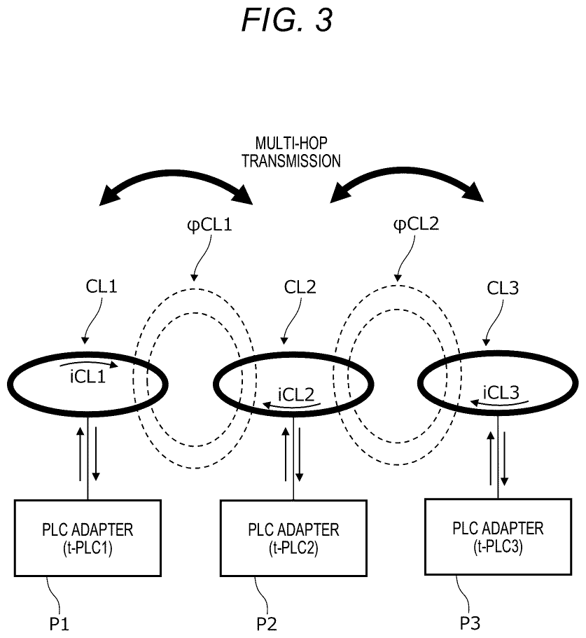

Next, multi-hop transmission between the transmission coils will be briefly described with reference to FIG. 3. FIG. 3 is a diagram showing an example of magnetic field coupling between the transmission coils arranged in a horizontal direction. In the description of FIG. 3, in order to simplify the description, three transmission coils (specifically, the transmission coils CL1, CL2, and CL3) and the PLC adapters (specifically, the PLC adapters P1, P2, and P3) corresponding to the respective transmission coils are shown.

In the resonance circuit of the transmission coil CL1, when a current iCL1 from the PLC adapter P1 (hereinafter also referred to as a “t-PLC1”) flows through the transmission coil CL1, a magnetic field φCL1 is generated around the transmission coil CL1. Vibration of the generated magnetic field φCL1 is wirelessly transmitted to the resonance circuit of the transmission coil CL2 that resonates at the same frequency as a resonance frequency of the resonance circuit of the transmission coil CL1. In this way, the magnetic field generated around the transmission coil CL1 and wirelessly transmitted to the transmission coil CL2 may be referred to as an interlinkage flux.

Similarly, in the resonance circuit of the transmission coil CL2, a current iCL2 is generated when the magnetic field φCL1 is excited in the transmission coil CL2 due to the vibration of the magnetic field φCL1 (in other words, the magnetic field coupling) which is the interlinkage flux. Therefore, a similar magnetic field φCL2 that is an interlinkage flux is also generated around the transmission coil CL2. The current iCL2 generated in the transmission coil CL2 due to the vibration of the magnetic field φCL1 is smaller than the current iCL1. Therefore, the PLC adapter 2 (hereinafter also referred to as a “t-PLC2”) performs control such as amplifying a level (magnitude) of the current iCL2 to a predetermined level. The predetermined level may be common to the PLC adapters P1 to P8, for example. Thus, the level (magnitude) of the magnetic field φCL2 is equal to the level (magnitude) of the magnetic field φCL1, and attenuation in data communication or power transmission between the transmission coils can be prevented. Further, the vibration of the generated magnetic field φCL2 is wirelessly transmitted to the resonance circuit of the transmission coil CL3 that resonates at the same frequency as the resonance frequency of the resonance circuits of the transmission coils CL1 and CL2.

Similarly, in the resonance circuit of the transmission coil CL3, a current iCL3 is generated when the magnetic field φCL2 is excited in the transmission coil CL3 due to the vibration of the magnetic field φCL2 (in other words, the magnetic field coupling) which is the interlinkage flux. Therefore, a similar magnetic field (not shown) that is an interlinkage flux is also generated around the transmission coil CL3. The current iCL3 generated in the transmission coil CL3 due to the vibration of the magnetic field φCL2 is smaller than the current iCL2 after amplification. Therefore, the PLC adapter 3 (hereinafter also referred to as a “t-PLC3”) performs control such as amplifying a level (magnitude) of the current iCL3 to a predetermined level. Thus, the level (magnitude) of the magnetic field φCL3 is equal to the level (magnitude) of the magnetic field φCL2, and attenuation in data communication or power transmission between the transmission coils can be prevented. Further, the vibration of the generated magnetic field φCL3 is wirelessly transmitted to the resonance circuit of the transmission coil CL4 that resonates at the same frequency as the resonance frequency of the resonance circuits of the transmission coils CL1, CL2, and CL3. Thus, the multi-hop transmission between the transmission coils enables continuous data communication or power transmission over a wide range.

In the above description, an example in which data communication or power transmission is performed in the order of the transmission coils CL1, CL2, and CL3 has been described, but the description is also similarly applicable to a case where data communication or power transmission is performed in a reverse direction, that is, in the order of the transmission coils CL3, CL2, and CL1.

FIG. 4 is a block diagram showing a hardware configuration example of the PLC adapters P0, P1, P2, P3, P4, P5, P6, P7, and P8. Since the hardware configuration examples of the respective PLC adapters are the same, the PLC adapter P1 will be described as an example. That is, the following description is similarly applicable to the hardware configuration examples of the respective PLC adapters P0, and P2 to P8.

The PLC adapter P1 performs digital signal processing using, for example, orthogonal frequency division multiplexing (ODFM) to perform communication. The PLC adapter P1 includes a controller 10, a memory 20, and an AFE 24. The controller 10 includes a central processing unit (CPU) 11, a power line communication (PLC)_physics (PHY) block 12, and a PLC_media access control (MAC) block 13.

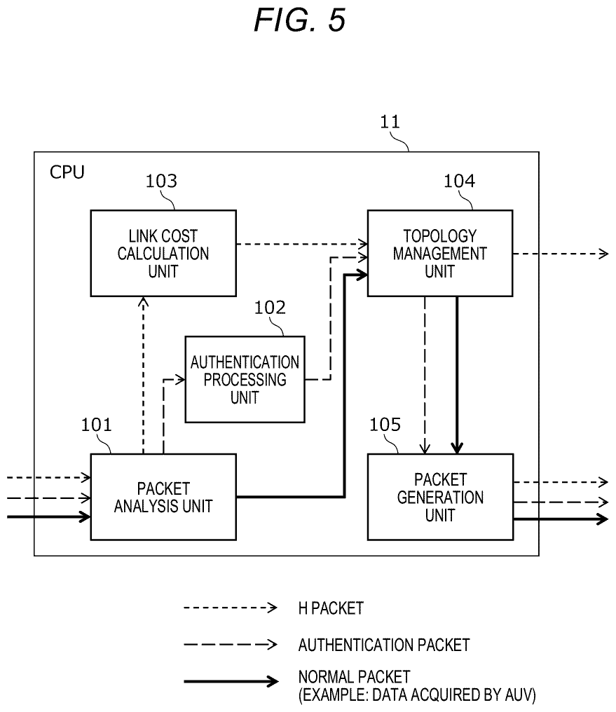

The CPU 11 controls processing of the PLC_MAC block 13 and the PLC_PHY block 12 by using programs and data stored in the memory 20, and controls processing of each unit of the PLC adapter P1. A functional configuration example of the CPU 11 will be described later with reference to FIG. 5.

The PLC_PHY block 12 manages, via the transmission coil (see FIG. 1), processing in a physical layer (PHY layer) of a transmission signal and a reception signal for performing data communication.

The PLC_MAC block 13 manages, via the transmission coil (see FIG. 1), processing in a media access control layer (MAC layer) of a transmission signal and a reception signal for performing data communication.

The AFE 24 includes a digital analog (DA) converter (not shown), an analog digital (AD) converter (not shown), and a variable amplifier (not shown). The AFE 24 converts a digital signal, which is a transmission signal to be input to the DA converter, into an analog signal and outputs the analog signal to a transmission coil (an example of the connected transmission coil) connected to the PLC adapter. The AFE 214 performs gain adjustment of an analog signal which is a reception signal input from the transmission coil (an example of the connected transmission coil) to the variable amplifier, amplifies the analog signal as appropriate, inputs the amplified signal to the AD converter, and converts the analog signal input to the AD converter into a digital signal.

Further, the PLC adapter P1 may include, for example, a wired local area network (LAN)_MAC block 19 corresponding to the Ethernet (registered trademark), an SDRAM controller 18, a flash memory interface 17, a general-purpose input/output (GPIO) 15, a universal asynchronous receiver/transmitter (UART) 16, and a clock IC 14. In FIG. 4, the interface is abbreviated as IF for convenience, and the clock is abbreviated as CLK for convenience.

A wired LAN_PHY block 23 corresponding to the Ethernet (registered trademark) is connected to the wired LAN_MAC block 19. The wired LAN_MAC block 19 manages, via a wired LAN cable (not shown), processing in the MAC layer of a transmission signal and a reception signal for performing data communication.

The wired LAN_PHY block 23 manages, via a wired LAN cable (not shown), processing in a PHY layer of a transmission signal and a reception signal for performing data communication.

The SDRAM controller 18 controls read processing and write processing for an SDRAM 22.

The flash memory interface 17 controls read processing and write processing for a flash memory 21.

The SDRAM 22 and the flash memory 21 may be a part of the memory 20.

The GPIO 15 is a general-purpose input/output interface.

The UART 16 performs serial-parallel conversion and parallel-serial conversion on received data and outputs the data.

The clock IC 14 supplies a clock synchronized with a signal oscillated by an oscillator (OSC) 25 to each unit. In FIG. 4, the oscillator is abbreviated as “OSC” for convenience.

The controller 10 performs basic control for data communication or digital signal processing including modulation and demodulation. The controller 10 modulates the data acquired in the wired LAN_PHY block 23 to generate a transmission signal, and outputs the transmission signal to the AFE 24. The controller 10 demodulates the reception signal, that is input from the transmission coil and acquired in the AFE 24, to generate reception data, and outputs the reception data to the wired LAN_PHY block 23.

The data communication in the PLC adapter P1 is performed in the following procedure.

In a case of transmission, the controller 10 receives data for transmission via the wired LAN_PHY block 23, and generates a digital signal for transmission by performing digital signal processing on the received data for transmission. The generated digital signal is input from the controller 10 to the AFE 24 and converted into an analog signal. The converted analog signal is transmitted to another transmission coil via the transmission coil (for example, the transmission coil CL1). In the digital signal processing, for example, modulation based on ODFM is performed.

In a case of reception, an analog signal received from another transmission coil via the transmission coil (for example, the transmission coil CL1) is input to the AFE 24, subjected to gain adjustment in the AFE 24, and then converted into a digital signal. The converted digital signal is input to the controller 10. The controller 10 performs digital signal processing on the received digital signal to acquire digital data. When the digital data is transmitted for the multi-hop transmission, the above-described transmission procedure is performed in a similar manner.

FIG. 5 is a block diagram showing a functional configuration example of the CPU 11 of each of the PLC adapters P0, P1, P2, P3, P4, P5, P6, P7, and P8. Since the functional configuration example of the CPU of each PLC adapter may be the same, the CPU 11 of the PLC adapter P1 will be described as an example. That is, the following description is similarly applicable to the functional configuration example of the CPU of each of the PLC adapters P0, and P2 to P8.

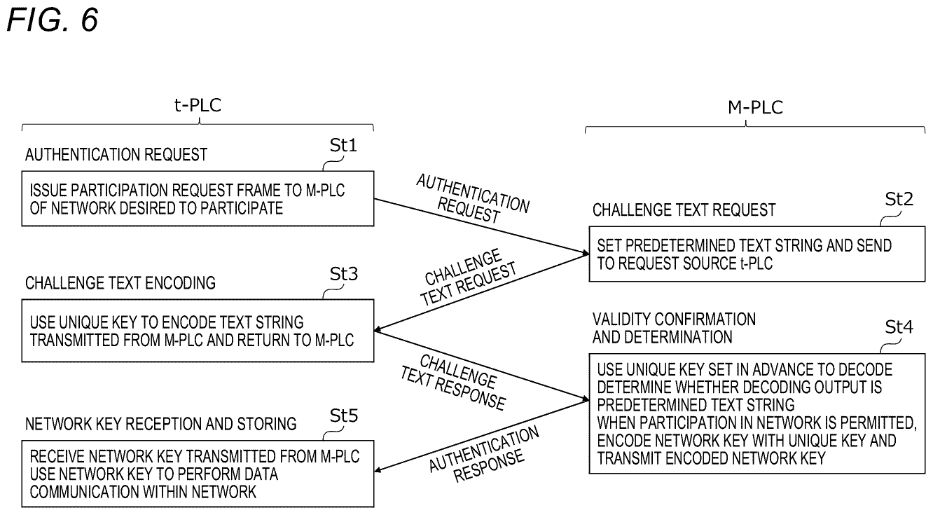

The CPU 11 functionally includes a packet analysis unit 101, an authentication processing unit 102, a link cost calculation unit 103, a topology management unit 104, and a packet generation unit 105. An H packet, an authentication packet, and a normal packet (for example, the data acquired by the AUV 30) are input to the CPU 11. The H packet is a packet that is simultaneously broadcast-transmitted from one PLC adapter to a PLC adapter in connection (in other words, connected to enable data communication via the transmission coil) prior to authentication processing (see FIG. 6) performed between the PLC adapters. The authentication packet is a packet that is transmitted and received during the authentication processing (see FIG. 6) performed between the PLC adapters.

The packet analysis unit 101 analyzes a data structure of various types of received packets (specifically, the H packet, the authentication packet, and the normal packet), determines the type of the packet, and distributes a transfer destination of the packet based on the determination result. For example, when it is determined that the received packet is the H packet, the packet analysis unit 101 sends the H packet to the link cost calculation unit 103. For example, when it is determined that the received packet is the authentication packet, the packet analysis unit 101 sends the authentication packet to the authentication processing unit 102. For example, when it is determined that the input packet is the normal packet, the packet analysis unit 101 sends the normal packet to the topology management unit 104.

When receiving the authentication packet from the packet analysis unit 101, the authentication processing unit 102 uses the authentication packet to perform authentication processing with a PLC adapter that is a transmission source of the authentication packet. The authentication processing unit 102 sends an authentication packet, which is a packet generated during the authentication processing, or a response of an authentication packet sent from another PLC adapter, to the topology management unit 104. Details of an operation procedure of the authentication processing will be described later with reference to FIG. 6.

When receiving the H packet from the packet analysis unit 101, the link cost calculation unit 103 uses the H packet to calculate a link cost (an example of a first cost or a second cost) indicating a reception quality of the H packet received by the PLC adapter including the CPU 11 from a PLC adapter which is a transmission source. The link cost calculation unit 103 writes a calculation result of the link cost into the data structure of the H packet. The H packet also stores a value of each link cost when the H packet is sent from the PLC adapter P0 (hereinafter referred to as an “M-PLC”). The link cost calculation unit 103 sends the H packet storing the calculation result of the link cost to the topology management unit 104.

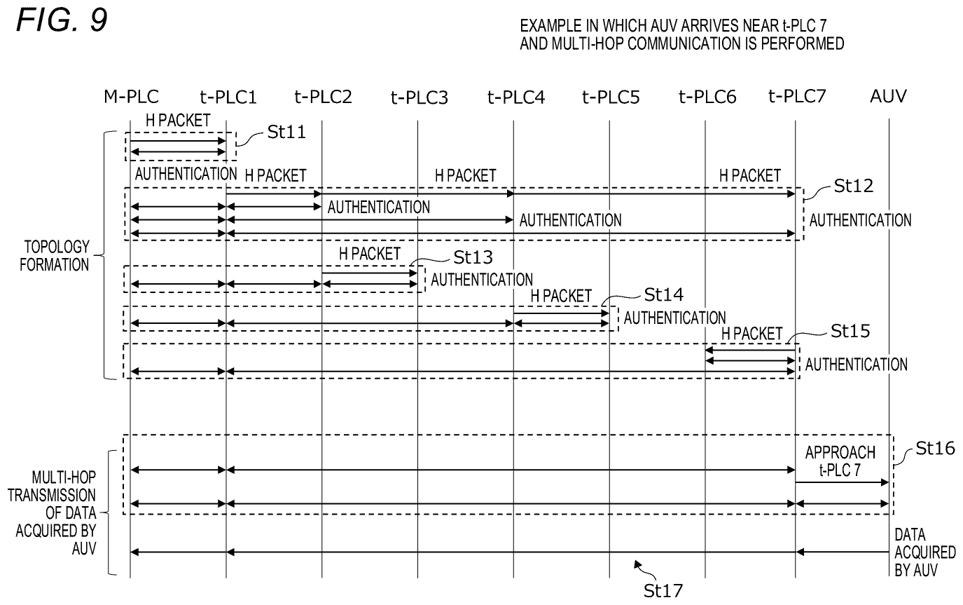

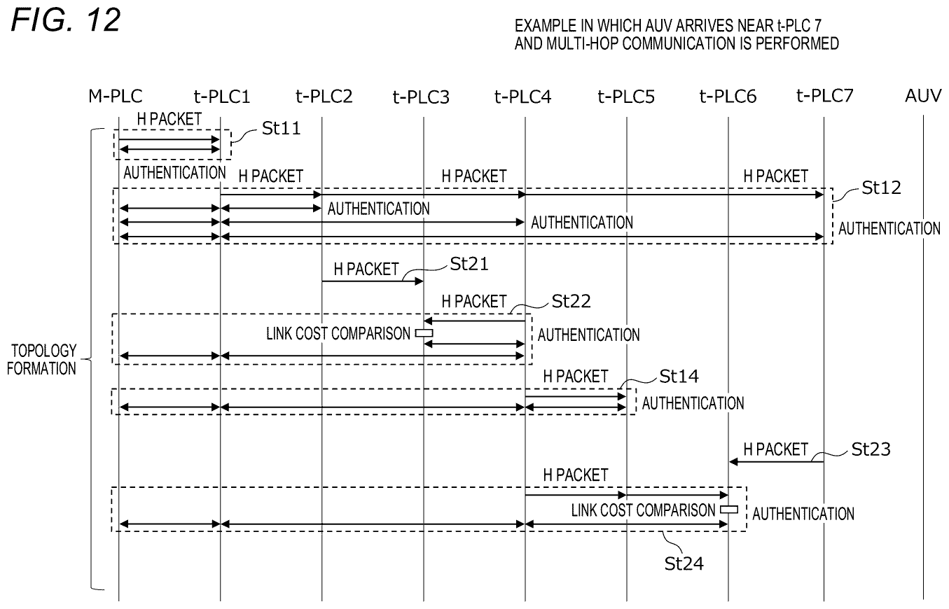

The topology management unit 104 manages data indicating a topology (that is, a connection mode of the PLC adapters P1 to P7 constituting the wireless data transmission system 100) generated by the M-PLC (that is, the PLC adapter P0), and distributes and outputs the data to output destinations (for example, the PLC_MAC block 13 or the packet generation unit 105) of various types of packets. The topology data is stored in the topology management unit 104 of the CPU 11 of each of the PLC adapters P0 to P8. The topology management unit 104 of the CPU 11 of the M-PLC (that is, the PLC adapter P0) generates (forms) a topology based on each link cost calculated by the link cost calculation unit 103 in response to the H packet sent from each of one or more PLC adapters targeted for the authentication processing. A detailed processing procedure example of topology generation processing using the link cost will be described later with reference to FIG. 9 or FIG. 12.

When receiving the authentication packet or the normal packet from the topology management unit 104, the packet generation unit 105 generates a packet for data communication with another transmission coil serving as a transmission destination or an H packet for performing authentication processing, and outputs the generated data or H packet.

Here, a processing procedure example of the authentication processing performed between the PLC adapters will be described with reference to FIG. 6. FIG. 6 is a sequence diagram showing a processing procedure example of authentication processing performed between the M-PLC and the t-PLC. In the description of FIG. 6, in order to simplify the description, a processing procedure of authentication processing performed between the M-PLC (that is, the PLC adapter P0 that generates a topology) and a PLC adapter (hereinafter referred to as a “t-PLC”) to be authenticated by the PLC adapter P0 will be briefly described. The processing shown in FIG. 6 is mainly performed by the authentication processing unit 102 of the CPU 11 of each PLC adapter. Prior to the description of FIG. 6, the M-PLC transmits an H packet to the t-PLC, and the t-PLC receives the H packet sent from the M-PLC.

In FIG. 6, the t-PLC issues an authentication packet including a participation request frame to the M-PLC (that is, the PLC adapter P0) of a network (for example, the wireless data transmission system 100) that is desired to participate, and sends the authentication packet to the M-PLC (St1). When receiving the authentication packet sent from the t-PLC in step St1, the M-PLC sets a predetermined text string to generate an authentication packet, and sends the authentication packet to a request source t-PLC (that is, the t-PLC that is an issuance source of the authentication packet sent in step St1) (St2).

The t-PLC uses a unique key that the t-PLC holds in advance in the memory 20 or the like (for example, a unique key held in advance by each of the PLC adapters P0 to P8) to encode the predetermined text string included in the authentication packet sent in step St2, generates an authentication packet including a text string that is an encoding output, and sends the authentication packet to the M-PLC (St3). When receiving the authentication packet sent from the t-PLC in step St3, the M-PLC uses the unique key (see the above) stored in advance in the memory 20 or the like to decode the text string that is the encoding output included in the authentication packet (St4). Further, the M-PLC determines whether the text string that is a decoding output matches the predetermined text string set in step St2 (St4). When it is determined that the text string that is the decoding output matches the predetermined text string set in step St2 (in other words, when it is determined that the participation in the wireless data transmission system 100 is permitted), the M-PLC encodes the network key unique to the wireless data transmission system 100 with the unique key (see the above) and transmits the encoded network key to the t-PLC (St4).

The t-PLC uses the unique key (see the above) to decode the encoded network key sent from the M-PLC in step St4 so as to acquire the network key (St5). Based on the acquisition of the network key, the t-PLC is formally authenticated as a data communication destination of the M-PLC. During data communication within the network (that is, the wireless data transmission system 100), the t-PLC performs data communication by encoding or decoding using the network key (St5).

The authentication processing of FIG. 6 described above is, for example, processing that is based on four-way handshake defined in standards of high-definition power line communication (HD-PLC), and the authentication processing may be processing that is based on a method other than the above-mentioned standards. For example, the authentication processing may be processing that is based on a method such as G.hn (Gigabit Home Networking), which is a unified standard of wired high-speed net communication technology, or HomePlug (HomePlug Powerline Alliance), which is an industry organization of power line carrier communication.

### First Operation Example

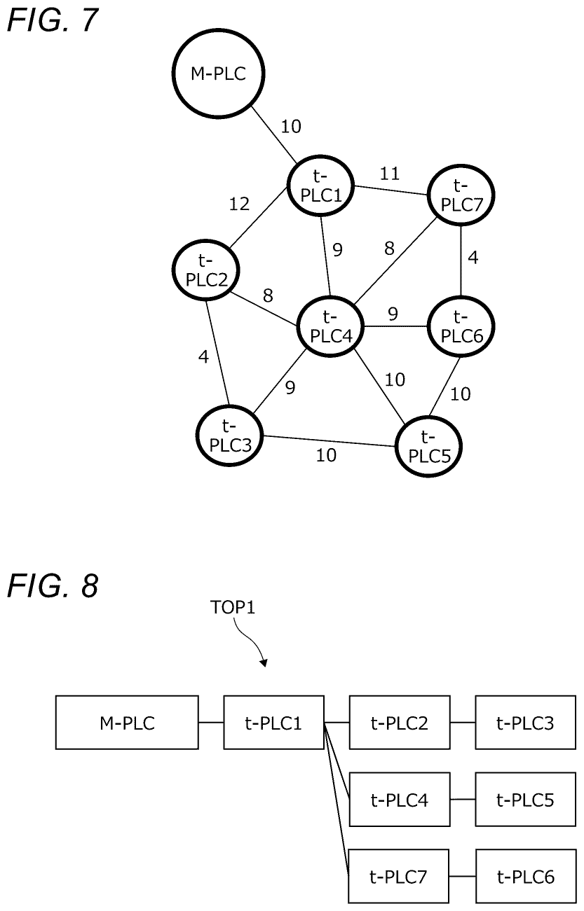

Next, in the wireless data transmission system 100 according to Embodiment 1, a first processing example of topology generation and multi-hop transmission between the M-PLC and each t-PLC (specifically, the t-PLC1, the t-PLC2, the t-PLC3, the t-PLC4, the t-PLC5, the t-PLC6, the t-PLC7, and the PLC adapter P8 provided in the AUV 30) will be described with reference to FIGS. 7, 8, and 9.

FIG. 7 is a diagram showing a first example of an arrangement of the PLC adapters and link costs between the PLC adapters. FIG. 8 is a diagram showing a first topology example. FIG. 9 is a sequence diagram showing a processing procedure example of the authentication processing performed between the various PLC adapters shown in FIG. 7. The authentication processing shown in FIG. 9 is at least performed once, for example, before an actual operation of the wireless data transmission system 100 according to Embodiment 1 is started.

The PLC adapters shown in FIG. 7 (that is, the M-PLC, the t-PLC1, the t-PLC2, the t-PLC3, the t-PLC4, the t-PLC5, the t-PLC6, and the t-PLC7) are arranged according to an arrangement example of various PLC adapters constituting the wireless data transmission system 100 shown in FIG. 1. A numeral described in the middle of a straight line connecting the PLC adapters indicates a link cost corresponding to a reception quality of an H packet transmitted from one PLC adapter toward another PLC adapter in the other PLC adapter.

For example, in FIG. 7, a link cost between the M-PLC and the t-PLC1 is 10, a link cost between the t-PLC1 and the t-PLC2 is 12, and a link cost between the t-PLC2 and the t-PLC3 is 4. A link cost between the t-PLC1 and the t-PLC4 is 9, and a link cost between the t-PLC4 and the t-PLC5 is 10. A link cost between the t-PLC1 and the t-PLC7 is 11, and a link cost between the t-PLC7 and the t-PLC6 is 4.

A link cost between the t-PLC2 and the t-PLC4 is 8, a link cost between the t-PLC4 and the t-PLC3 is 9, a link cost between the t-PLC4 and the t-PLC7 is 8, a link cost between the t-PLC4 and the t-PLC6 is 9, a link cost between the t-PLC3 and the t-PLC5 is 10, and a link cost between the t-PLC6 and the t-PLC5 is 10.

Therefore, a topology TOP1 shown in FIG. 8 is generated by the M-PLC (that is, the PLC adapter P0) according to the processing procedure of the authentication processing shown in FIG. 9. The topology TOP1 may be generated by a PLC adapter other than the M-PLC (for example, any one of the t-PLC1 to t-PLC7). According to the topology TOP1, “M-PLC, t-PLC1, t-PLC2, t-PLC3” is formed as a first multi-hop transmission path, “M-PLC, t-PLC1, t-PLC4, t-PLC5” is formed as a second multi-hop transmission path, and “M-PLC, t-PLC1, t-PLC7, t-PLC6” is formed as a third multi-hop transmission path.

Therefore, for example, when the AUV 30 performs authentication processing with the t-PLC3, the data acquired by the AUV 30 in the ocean exploration or the like is transmitted in the order of “t-PLC3->t-PLC2->t-PLC1->M-PLC” according to the first multi-hop transmission path.

Further, for example, when the AUV 30 performs authentication processing with the t-PLC5, the data acquired by the AUV 30 in the ocean exploration or the like is transmitted in the order of “t-PLC5->t-PLC4->t-PLC1->M-PLC” according to the second multi-hop transmission path.

Further, for example, when the AUV 30 performs authentication processing with the t-PLC6, the data acquired by the AUV 30 in the ocean exploration or the like is transmitted in the order of “t-PLC6->t-PLC7->t-PLCI->M-PLC” according to the third multi-hop transmission path.

In FIG. 9, the M-PLC simultaneously broadcast-transmits an H packet to each of the t-PLCs (for example, the t-PLC1, the t-PLC2, the t-PLC3, the t-PLC4, the t-PLC5, the t-PLC6, and the t-PLC7) (St11). It is assumed that only the t-PLC1 can receive the H packet in response to the broadcast transmission. Then, the authentication processing described with reference to FIG. 6 is performed between the M-PLC and the t-PLC1 (St11). Thus, data communication between the M-PLC and the t-PLC1 is enabled.

Next, the t-PLC1 simultaneously broadcast-transmits an H packet to other t-PLCs other than the self-terminal (for example, the M-PLC, the t-PLC2, the t-PLC3, the t-PLC4, the t-PLC5, the t-PLC6, and the t-PLC7) (St12). It is assumed that only the t-PLC2, the t-PLC4, and the t-PLC7 can receive the H packet in response to the broadcast transmission. Then, the authentication processing described with reference to FIG. 6 is performed between the t-PLC2 and the M-PLC via the t-PLC1 (St12). Similarly, the authentication processing described with reference to FIG. 6 is performed between the t-PLC4 and the M-PLC via the t-PLC1 (St12). The authentication processing described with reference to FIG. 6 is performed between the t-PLC7 and the M-PLC via the t-PLC1 (St12). Thus, data communication between the M-PLC and the t-PLC2 via the t-PLC1, between the M-PLC and the t-PLC4 via the t-PLC1, and between the M-PLC and the t-PLC7 via the t-PLC1 is enabled.

Further, the t-PLC2 simultaneously broadcast-transmits an H packet to other t-PLCs other than the self-terminal (for example, the M-PLC, the t-PLC1, the t-PLC3, the t-PLC4, the t-PLC5, the t-PLC6, and the t-PLC7) (St13). It is assumed that only the t-PLC3 can receive the H packet in response to the broadcast transmission. Then, the authentication processing described with reference to FIG. 6 is performed between the t-PLC3 and the M-PLC via the t-PLC1 and the t-PLC2 (St13). Thus, data communication between the M-PLC and the t-PLC3 via the t-PLC1 and the t-PLC2 is enabled.

Further, the t-PLC4 simultaneously broadcast-transmits an H packet to other t-PLCs other than the self-terminal (for example, the M-PLC, the t-PLC1, the t-PLC2, the t-PLC3, the t-PLC5, the t-PLC6, and the t-PLC7) (St14). It is assumed that only the t-PLC5 can receive the H packet in response to the broadcast transmission. Then, the authentication processing described with reference to FIG. 6 is performed between the t-PLC5 and the M-PLC via the t-PLC1 and the t-PLC4 (St14). Thus, data communication between the M-PLC and the t-PLC5 via the t-PLC1 and the t-PLC4 is enabled.

Further, the t-PLC7 simultaneously broadcast-transmits an H packet to other t-PLCs other than the self-terminal (for example, the M-PLC, the t-PLC1, the t-PLC2, the t-PLC3, the t-PLC4, the t-PLC5, and the t-PLC6) (St15). It is assumed that only the t-PLC6 can receive the H packet in response to the broadcast transmission. Then, the authentication processing described with reference to FIG. 6 is performed between the t-PLC6 and the M-PLC via the t-PLC1 and the t-PLC7 (St15). Thus, data communication between the M-PLC and the t-PLC6 via the t-PLC1 and the t-PLC7 is enabled.

Here, it is assumed that the AUV 30 approaches the t-PLC7 when the t-PLC7 completes the authentication processing with the M-PLC, and the t-PLC7 and the M-PLC can be connected (St16). At this time, the t-PLC7 and the AUV 30 perform connection preparation for performing data communication via the transmission coils CL7 and CL8.

The t-PLC7 transmits an H packet to the AUV 30 (in other words, the PLC adapter P8) (St16). It is assumed that the PLC adapter P8 can receive the H packet in response to the transmission. Then, the authentication processing described with reference to FIG. 6 is performed between the PLC adapter P8 and the M-PLC via the t-PLC7 and the t-PLC1 (St16). Thus, data communication between PLC adapter P8 (in other words, the AUV 30) and the M-PLC via the t-PLC7 and the t-PLC1 is enabled. That is, the data acquired by the AUV 30 is transmitted in the order of PLC adapter P8->t-PLC7->t-PLC1->M-PLC and is acquired in the M-PLC (St17).

### Second Operation Example

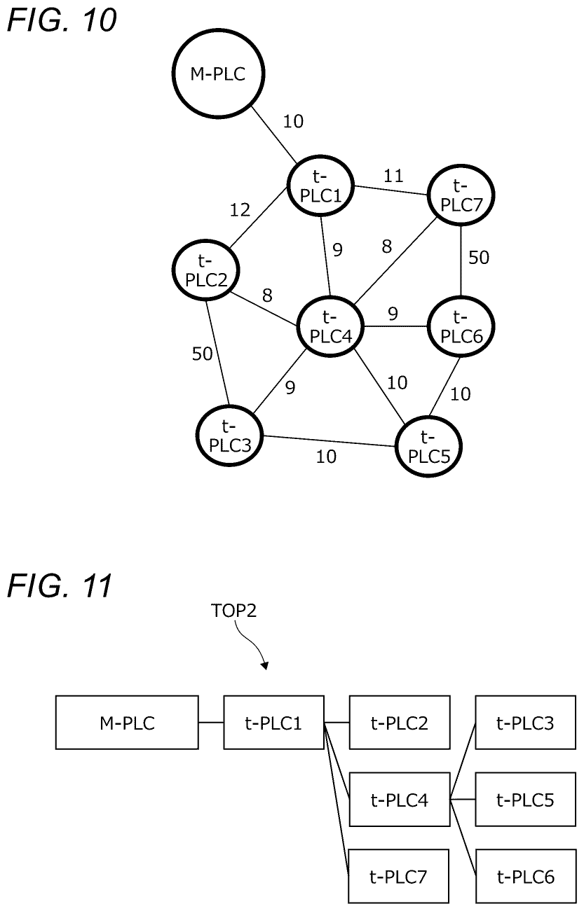

Next, in the wireless data transmission system 100 according to Embodiment 1, a second processing example of the topology generation and the multi-hop transmission between the M-PLC and each t-PLC (specifically, the t-PLC1, the t-PLC2, the t-PLC3, the t-PLC4, the t-PLC5, the t-PLC6, the t-PLC7, and the PLC adapter P8 provided in the AUV 30) will be described with reference to FIGS. 10, 11, and 12.

FIG. 10 is a diagram showing a second example of the arrangement of the PLC adapters and the link costs between the PLC adapters. FIG. 11 is a diagram showing a second topology example. FIG. 12 is a sequence diagram showing a processing procedure example of authentication processing performed between the various PLC adapters shown in FIG. 10. The authentication processing shown in FIG. 12 is at least performed once, for example, before an actual operation of the wireless data transmission system 100 according to Embodiment 1 is started. In the description of FIG. 12, description of contents the same as those of FIG. 9 will be given the same step numbers and will be simplified or omitted, and different contents will be described. In FIG. 12, a processing procedure the same as the processing procedure of transmitting the data acquired by the AUV 30 to the M-PLC and shown in FIG. 9 is performed in a similar manner after a topology TOP2 is generated, and the illustration is omitted.

The PLC adapters shown in FIG. 10 (that is, the M-PLC, the t-PLC1, the t-PLC2, the t-PLC3, the t-PLC4, the t-PLC5, the t-PLC6, and the t-PLC7) are arranged according to the arrangement example of various PLC adapters constituting the wireless data transmission system 100 shown in FIG. 1. A numeral described in the middle of a straight line connecting the PLC adapters indicates a link cost corresponding to a reception quality of an H packet transmitted from one PLC adapter toward another PLC adapter in the other PLC adapter.

For example, in FIG. 10, a link cost between the M-PLC and the t-PLC1 is 10, a link cost between the t-PLC1 and the t-PLC2 is 12, but a link cost between the t-PLC2 and the t-PLC3 is 50, which is a difference from FIG. 7. That is, as compared with a state shown in FIG. 7, since the link cost between the t-PLC2 and the t-PLC3 is high, it is difficult to connect the t-PLC2 and the t-PLC3. A link cost between the t-PLC1 and the t-PLC4 is 9, and a link cost between the t-PLC4 and the t-PLC5 is 10. A link cost between the t-PLC1 and the t-PLC7 is 11, but a link cost between the t-PLC7 and the t-PLC6 is 50, which is a difference from FIG. 7. That is, as compared with the state shown in FIG. 7, since the link cost between the t-PLC7 and the t-PLC6 is high, it is difficult to connect the t-PLC7 and the t-PLC6.

A link cost between the t-PLC2 and the t-PLC4 is 8, a link cost between the t-PLC4 and the t-PLC3 is 9, a link cost between the t-PLC4 and the t-PLC7 is 8, a link cost between the t-PLC4 and the t-PLC6 is 9, a link cost between the t-PLC3 and the t-PLC5 is 10, and a link cost between the t-PLC6 and the t-PLC5 is 10.

Therefore, a topology TOP2 shown in FIG. 11 is generated by the M-PLC (that is, the PLC adapter P0) according to the processing procedure of the authentication processing shown in FIG. 12. The topology TOP2 may be generated by a PLC adapter other than the M-PLC (for example, any one of the t-PLC1 to t-PLC7). According to the topology TOP2, “M-PLC, t-PLC1, t-PLC2” is formed as a first multi-hop transmission path, “M-PLC, t-PLC1, t-PLC4, t-PLC5” is formed as a second multi-hop transmission path, “M-PLC, t-PLC1, t-PLC4, t-PLC3” is formed as a third multi-hop transmission path, “M-PLC, t-PLC1, t-PLC4, t-PLC6” is formed as a fourth multi-hop transmission path, and “M-PLC, t-PLC1, t-PLC7” is formed as a fifth multi-hop transmission path.

Therefore, for example, when the AUV 30 performs authentication processing with the t-PLC3, the data acquired by the AUV 30 in the ocean exploration or the like is transmitted in the order of “t-PLC3->t-PLC4->t-PLCI->M-PLC” according to the third multi-hop transmission path.

Further, for example, when the AUV 30 performs authentication processing with the t-PLC2, the data acquired by the AUV 30 in the ocean exploration or the like is transmitted in the order of “t-PLC2->t-PLCI->M-PLC” according to the first multi-hop transmission path.

Further, for example, when the AUV 30 performs authentication processing with the t-PLC6, the data acquired by the AUV 30 in the ocean exploration or the like is transmitted in the order of “t-PLC6->t-PLC4->t-PLCI->M-PLC” according to the fourth multi-hop transmission path.

In FIG. 12, the t-PLC2 simultaneously broadcast-transmits an H packet to other t-PLCs other than the self-terminal (for example, the M-PLC, the t-PLC1, the t-PLC3, the t-PLC4, the t-PLC5, and the t-PLC6, and the t-PLC7) (St21). It is assumed that only the t-PLC1, the t-PLC3, and the t-PLC4 can receive the H packet in response to the broadcast transmission. Further, the t-PLC4 simultaneously broadcast-transmits an H packet to other t-PLCs other than the self-terminal (for example, the M-PLC, the t-PLC1, the t-PLC2, the t-PLC3, the t-PLC5, the t-PLC6, and the t-PLC7) (St22). It is assumed that only the t-PLC3, the t-PLC5, and the t-PLC6 can receive the H packet in response to the broadcast transmission.

The t-PLC3 calculates a link cost of the H packet transmitted from the t-PLC2 and a link cost of the H packet transmitted from the t-PLC4, and compares the calculation results.

Then, the t-PLC3 compares a total value of a link cost indicating a reception quality of the H packet sent in step St21 (for example, “50” shown in FIG. 10) and a sum of link costs indicating a reception quality from the t-PLC2 to the M-PLC (for example, “12”+“10”=“22” shown in FIG. 10), and a total value of a link cost indicating a reception quality of the H packet sent in step St22 (for example, “9” shown in FIG. 10) and a sum of link costs indicating a reception quality from the t-PLC4 to the M-PLC (for example, “9”+“10”=“19” shown in FIG. 10) (St22).

Based on the comparison in step St22, the t-PLC3 determines the t-PLC4 having a smaller total value of the link costs (that is, having a better a connection state) as the data communication partner of the multi-hop transmission (St22). Then, the authentication processing described with reference to FIG. 6 is performed between the t-PLC3 and the M-PLC via the t-PLC1 and the t-PLC4 (St22). Thus, data communication between the M-PLC and the t-PLC3 via the t-PLC1 and the t-PLC4 is enabled.

Further, the t-PLC7 simultaneously broadcast-transmits an H packet to other t-PLCs other than the self-terminal (for example, the M-PLC, the t-PLC1, the t-PLC2, the t-PLC3, the t-PLC4, the t-PLC5, and the t-PLC6) (St23). It is assumed that only the t-PLC6 can receive the H packet in response to the broadcast transmission. Further, the t-PLC4 simultaneously broadcast-transmits an H packet to other t-PLCs other than the self-terminal (for example, the M-PLC, the t-PLC1, the t-PLC2, the t-PLC3, the t-PLC5, the t-PLC6, and the t-PLC7) (St24). It is assumed that only the t-PLC5 and the t-PLC6 can receive the H packet in response to the broadcast transmission. Then, the authentication processing described with reference to FIG. 6 is performed between the t-PLC5 and the M-PLC via the t-PLC1 and the t-PLC4 (St24). Further, the t-PLC6 compares a total value of a link cost indicating a reception quality of the H packet sent in step St23 (for example, “50” shown in FIG. 10) and a sum of link costs indicating a reception quality from the t-PLC7 to the M-PLC (for example, “11”+“10”=“21” shown in FIG. 10), and a total value of a link cost indicating a reception quality of the H packet sent in step St24 (for example, “9” shown in FIG. 10) and a sum of link costs indicating a reception quality from the t-PLC4 to the M-PLC (for example, “9”+“10”=“19” shown in FIG. 10) (St24).

Based on the comparison in step St24, the t-PLC6 determines the t-PLC4 having a smaller total value of the link costs (that is, having a better a connection state) as the data communication partner of the multi-hop transmission (St24). Then, the authentication processing described with reference to FIG. 6 is performed between the t-PLC6 and the M-PLC via the t-PLC1 and the t-PLC4 (St24). Thus, data communication between the M-PLC and the t-PLC6 via the t-PLC1 and the t-PLC4 is enabled.

As described above, the wireless data transmission system 100 according to Embodiment 1 includes N (N is an integer equal to or greater than 2) transmission coils CL1 to CL7 each having an opening surface and each disposed under water such that the opening surface faces vertically upward, and N communication devices (for example, the PLC adapters P1 to P7) each connected in a one-to-one correspondence to a connected transmission coil which is any one of the N transmission coils and each configured to perform data communication via the corresponding connected transmission coil. Each of the communication devices performs multi-hop transmission of data, that is acquired by a data acquiring device (for example, the AUV 30) movable under the water, based on a topology generated in advance and indicating a connection mode between the N communication devices and magnetic field coupling occurring between the connected transmission coil and at least one of other connected transmission coils adjacent thereto.

Thus, since the wireless data transmission system 100 can perform multi-hop transmission of data acquired by the AUV 30 when performing the ocean exploration in a state where the N transmission coils are disposed in a horizontal direction in a range that occupies a wide area of an environment (for example, under the sea or the seafloor) to be subjected to the ocean exploration, large-capacity data communication can be performed at a high speed and stably.

Further, the communication device performs generation processing of the topology based on transmission of a predetermined packet (for example, the H packet) to at least one of other communication devices and a reception response of the transmitted predetermined packet. Thus, since the topology defining a transmission destination and a transmission source of the packet is efficiently generated in consideration of communication that can be said to be in a dynamic state between the transmission coils disposed under the sea where interference with ocean currents or marine organisms may occur, a data communication quality of the wireless data transmission system 100 is improved.

Further, when the communication device receives the data sent from one of the other connected transmission coils serving as a transmission source specified by the topology, the communication device controls transmission power of the received data to a predetermined value, and performs multi-hop transmission of the data to one of the other connected transmission coils serving as a transmission destination specified by the topology. Thus, deterioration of a reception signal level of the data can be prevented each time the data acquired by the AUV 30 in the ocean exploration or the like is transmitted between the transmission coils. and the wireless data transmission system 100 can stably perform data communication.

The wireless data transmission system 100 further includes a master communication device (for example, the PLC adapter PO) that serves as a parent device of the N communication devices and that is connected to enable data communication with each of the N communication devices. When receiving the predetermined packet from each of relay devices that are at least two of the communication devices which are adjacent to the communication device (for example, the t-PLC2 and the t-PLC4 with respect to the t-PLC3), the communication device determines one of the relay devices serving as a data communication destination based on a first cost (for example, a link cost of the H packet received by the t-PLC3 from the t-PLC2 or the t-PLC4) indicating a reception quality of the predetermined packet received from the relay device and a sum of second costs (for example, as sum of link costs from the t-PLC2 to the M-PLC. or a sum of link costs from the t-PLC4 to the M-PLC) indicating a reception quality of the predetermined packet from the relay device to the master communication device. Thus, even when a communication environment may vary depending on an environment under the sea where interference with ocean currents or marine organisms may occur, a PLC adapter which is not easily disconnected (in other words, makes data communication easy) can be selected, so that the wireless data transmission system 100 can perform data communication stably.

Further, each of the N communication devices is disposed under the water. Thus, the wireless data transmission system 100 can also perform large-capacity data communication at a high speed and stably under the water (for example, under the sea).

Further, the master communication device is disposed on a facility (for example, the ship SH1) on the water. The communication device transmits the data to the master communication device through the multi-hop transmission. Thus, the wireless data transmission system 100 can efficiently aggregate the data, which is acquired by the AUV 30 in the ocean exploration or the like, into a management device such as the PC1 provided on a facility on the water such as the ship SH1.

Although various embodiments have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the various embodiments described above may be freely combined without departing from the gist of the invention.

Although various embodiments have been described above with reference to the drawings, it is needless to say that the present invention is not limited to these embodiments. It is apparent that those skilled in the art can conceive of various modifications and alterations within the scope described in the claims, and it is understood that such modifications and alterations naturally fall within the technical scope of the present invention. The components in the embodiment described above may be freely combined without departing from the gist of the invention.

The present application is based on Japanese Patent Application No. 2021-156850 filed on Sep. 27, 2021, and the contents thereof are incorporated herein by reference.

### INDUSTRIAL APPLICABILITY

The present disclosure is useful as a data transmission system and a data transmission method for performing large-capacity data communication at a high speed and stably in a wide range such as the sea.

### REFERENCE SIGNS LIST

1: PC
10: controller
11: CPU
12: PLC_PHY block
13: PLC MAC block
14: CLK
15: GPIO
16: UART
17: flash memory interface
18: SDRAM controller
19: wired LAN_MAC block
20: memory
21: flash memory
22: SDRAM
23: wired LAN_PHY block
24: AFE
25: OSC
30: AUV
70: power supply facility
100: wireless data transmission system
101: packet analysis unit
102: authentication processing unit
103: link cost calculation unit
104: topology management unit
105: packet generation unit
CL1, CL2, CL3, CL4, CL5, CL6, CL7, CL8: transmission coil
P0, P1, P2, P3, P4, P5, P6, P7, P8 PLC: adapter

What is claimed is:

1. A wireless data transmission system comprising:
N (N is an integer equal to or greater than 2) transmission coils each having an opening surface and each disposed under water such that the opening surface faces vertically upward; and
N communication devices each connected in a one-to-one correspondence to a connected transmission coil which is any one of the N transmission coils and each configured to perform data communication via the corresponding connected transmission coil, wherein
each of the communication devices performs multi-hop transmission of data, that is acquired by a data acquiring device movable under the water, based on a topology generated in advance and indicating a connection mode between the N communication devices and magnetic field coupling occurring between the connected transmission coil and at least one of other connected transmission coils adjacent thereto.

2. The wireless data transmission system according to claim 1, wherein
the communication device performs generation processing of the topology based on transmission of a predetermined packet to at least one of other communication devices and a reception response of the transmitted predetermined packet.

3. The wireless data transmission system according to claim 1, wherein
when the communication device receives the data sent from one of the other connected transmission coils serving as a transmission source specified by the topology, the communication device controls transmission power of the received data to a predetermined value, and performs multi-hop transmission of the data to one of the other connected transmission coils serving as a transmission destination specified by the topology.

4. The wireless data transmission system according to claim 2, further comprising:
a master communication device that serves as a parent device of the N communication devices and that is connected to enable data communication with each of the N communication devices, wherein
when receiving the predetermined packet from each of relay devices that are at least two of the communication devices which are adjacent, the communication device determines one of the relay devices serving as a data communication destination based on a first cost indicating a reception quality of the predetermined packet received from the relay device and a sum of second costs indicating a reception quality of the predetermined packet from the relay device to the master communication device.

5. The wireless data transmission system according to claim 1, wherein
each of the N communication devices is disposed under the water.

6. The wireless data transmission system according to claim 4, wherein
the master communication device is disposed on a facility on the water, and
the communication device transmits the data to the master communication device through the multi-hop transmission.

7. A wireless data transmission method comprising:
using N (N is an integer equal to or greater than 2) transmission coils each having an opening surface and each disposed under water such that the opening surface faces vertically upward, and N communication devices each connected in a one-to-one correspondence to a connected transmission coil which is any one of the N transmission coils and each configured to perform data communication via the corresponding connected transmission coil; and
performing multi-hop transmission of data, that is acquired by a data acquiring device movable under the water, based on a topology generated in advance and indicating a connection mode between the N communication devices and magnetic field coupling occurring between the connected transmission coil and at least one of other connected transmission coils adjacent thereto.
